(19) United States
(12) Patent Application Publication
(10) Pub. No.: US 2011/0205210 A1
(43) Pub. Date: Aug. 25, 2011

(54) DISPLAY APPARATUS

(75) Inventors: Takanori Yamashita, Chiba-shi (JP); Tatsuhito Goden, Chiba-shi (JP)

(73) Assignee: CANON KABUSHIKI KAISHA, Tokyo (JP)

(21) Appl. No.: 13/030,401

(22) Filed: Feb. 18, 2011

(30) Foreign Application Priority Data
Feb. 22, 2010 (JP) 2010-036553

(51) Int. Cl. G06F 3/038

(52) U.S. Cl. 345/211

(57) ABSTRACT

In a display apparatus, after sampling switches turn on and a voltage signal to be held in a driving circuit is transmitted to a plurality of data lines and subsequently the sampling switches turn off, a selected scanning line supplies a control signal to the driving circuits along the selected scanning line, thereby causing the driving circuits to hold the voltage signal, and the plurality of scanning lines supply a control signal to the driving circuits simultaneously, and thereafter the sampling switches turn on and the voltage signal which is to cause the driving circuit to drive the display element is transmitted to the data lines thereby causing the driving circuits along the plurality of scanning lines to drive the display element simultaneously.

### BACKGROUND OF THE INVENTION

1. Field of the Invention

The present invention relates to a display apparatus, and more particularly, to a display apparatus using an organic electroluminescent element that emits light when a current is injected thereinto.

2. Description of the Related Art

An active matrix type display apparatus is configured such that a plurality of pixels each including a display element and a driving circuit are disposed at intersections between a plurality of parallel scanning lines and a plurality of data lines crossing the scanning lines. Each driving circuit is supplied with an independent data signal thereby driving a corresponding display element. Each display element is composed of a liquid crystal, an organic electroluminescent material, or the like. Light emitted by the display element emits is controlled by a current or a voltage applied thereto.

A data signal is generated by a data signal generation circuit and output to data lines. The data signal generation circuit may be disposed immediately outside a display area in which display elements are disposed in the form of a matrix and may be directly connected to the data lines, or the data signal generation circuit may be disposed on an integrated circuit chip mounted in a peripheral part of the display apparatus and may generate data signals at this location. In the latter configuration, transmission of data signals from output terminals of the data signal generation circuit to the respective data lines is performed via wirings disposed outside the display area.

In many display apparatuses, to reduce the circuit scale of the data signal generation circuit, the number of outputs of the data signal generation circuit is set to be 1/r of the number of data lines (where r is an integer equal to or greater than 2), and data signals are transmitted over r data lines using a time division multiplex technique. The outputs of the data signal generation circuit are connected to the data lines via 1-to-r sampling switches. The sampling switches are sequentially turned on to transfer data. This configuration allows a reduction in an area occupied by wirings that transmit data signals.

In the configuration in which the outputs of the data signal generation circuit are transmitted over the data lines using the time division multiplex technique, it is necessary to hold data signals on the data lines. The data lines are formed of electrically conductive wires extending in a column direction on a substrate on which the display apparatus is formed. A plurality of scanning lines are also formed of electrically conductive wires such that they extend in a row direction and such that they cross the scanning lines via an insulating layer. In this structure, parasitic capacitance occurs at each intersection between a data line and a scanning line, and thus each data line has sufficiently large capacitance to hold a data signal. Note that the capacitance of each data line D is the sum of parasitic capacitance Cs at intersections between the data line D and scanning lines P. When there are n scanning lines, the capacitance of each data line is equal to n.Cs. The parasitic capacitance Cs depends on widths of the data lines and the scanning lines disposed on the substrate and also depends on the dielectric constant of the insulating layer between the data lines and the scanning lines, and thus it is easy to control the magnitude of parasitic capacitance Cs.

The driving circuits of pixels are selected in units of scanning lines by control signals supplied via scanning lines, and data signals are captured into the selected driving circuits. The captured data signals are held in the driving circuits, and voltages or currents corresponding to the data signals are supplied to corresponding display elements. Correspondingly, the display elements operate and thus an image is displayed.

U.S. Pat. No. 6,950,081 discloses an organic electroluminescent display apparatus in which a capacitor is disposed in series between a data line and a driving circuit. The capacitor functions as a coupling capacitor that transfers a voltage signal on the data line to the driving circuit and also functions as a holding capacitor for holding this voltage signal. In a period in which a driving circuit is selected by a control signal supplied via a scanning line, a reset signal is applied to the driving circuit to delete a voltage previously held in the driving circuit, and a voltage on a terminal of the capacitor opposite to a terminal connected to the data line is reset. When the selection period ends, the terminal that has been subjected to the voltage resetting is brought into a high impedance state in which no current flows anywhere from this terminal. As a result, a voltage equal to the difference between the data signal and the reset voltage is held across the capacitor. After the holding of the data signal by the capacitor is completed in all driving circuits, if the data line is set to be at a predetermined reference potential, then the terminal that has been subjected to the voltage resetting comes to have a voltage corresponding to the data signal. This voltage is applied to the gate of the driving transistor, and thus a driving current is generated and supplied to the display element. Thus light is emitted and an image is displayed.

In the display apparatus disclosed in U.S. Pat. No. 6,950,081, two scanning lines are provided in each row. One of the two scanning lines is used to sequentially select driving circuits and reset the capacitor terminals, and the other one of the two scanning lines is used to control turning-on/off of the current between the driving transistor and the organic electroluminescent element.

In the circuit configuration in which a capacitor for holding a data signal is provided between a data line and a driving circuit, a control signal for selecting scanning lines is applied sequentially on a row-by-row basis and data signals are held in driving circuits in each row. Thereafter, data lines are set to be at a reference potential. The reference voltage is generated outside the display apparatus as with the data signals, and applied to the data lines via sampling switches. When the sampling switches are turned off after the data lines are set to be at the reference voltage, the data lines are brought into a high impedance state, while the reference potential is held by parasitic capacitance at intersections between the data lines and the scanning lines.

Each data line crosses many (n) scanning lines. When the control signal is switched from one scanning line to another, no significant change occurs in potential of the data line. However, if control signals are applied to all scanning lines at the same time, the parasitic capacitance between the scanning lines and the data lines causes the reference voltage set at the data lines to fluctuate by being influenced by the control signals applied to the scanning lines. If the reference voltage fluctuates, the gate potential of the driving transistor is changed via the capacitor of each driving circuit, which causes the voltage or the current applied to the display element to deviate from a correct value corresponding to the data signal. Thus, it becomes difficult to display an image faithfully according to the data signal.

### SUMMARY OF THE INVENTION

According to an aspect of the present invention, there is provided a display apparatus comprising a plurality of display elements and a plurality of driving circuits for driving the respective display element, both arranged in the form of a matrix, a plurality of data lines each configured to hold a voltage signal and supply the voltage signal to the driving circuits arranged in a column of the matrix, a plurality of scanning lines intersecting the plurality of data lines each configured to supply a control signal to the driving circuits arranged in a row of the matrix, and a plurality of video signal lines configured to transmit the voltage signal to the plurality of data lines via a plurality of sampling switches connected between the plurality of video signal lines and the plurality of data lines, wherein the plurality of scanning lines are configured such that after the sampling switches turn on and the voltage signal which is to be held in the driving circuit is transmitted to the plurality of data lines and subsequently the sampling switches turn off, a scanning line selected from the plurality of scanning lines supplies the control signal to the driving circuits thereby causing the driving circuits along the selected scanning line to hold the voltage signal, the plurality of scanning lines supply the control signal to the driving circuits simultaneously, and thereafter the sampling switches turn on and the voltage signal which causes the driving circuit to drive the display element is transmitted to the plurality of data lines thereby causing the driving circuits along the plurality of scanning lines to drive the display elements simultaneously.

In this display apparatus, after the control signal that simultaneously selects all rows is supplied, the reference voltage is applied to the data lines via the sampling switch, and thus no simultaneous change in potential of scanning lines occurs after the data lines are set at the reference potential. Therefore, the reference potential is prevented from being changed, and thus an image is correctly displayed without being influenced.

Further features of the present invention will become apparent from the following description of exemplary embodiments with reference to the attached drawings.

### BRIEF DESCRIPTION OF THE DRAWINGS

FIG. 1 is a block diagram illustrating a total configuration of a display apparatus according to an embodiment of the present invention.

FIG. 2 is a circuit diagram illustrating a configuration of a pixel according to an embodiment of the present invention.

FIG. 3 is a timing chart illustrating an operation according to an embodiment of the present invention.

FIG. 4 is a circuit diagram illustrating a configuration of a pixel according to an embodiment of the present invention.

FIG. 5 is a timing chart illustrating an operation according to an embodiment of the present invention.

FIG. 6 is a circuit diagram illustrating a configuration of a pixel according to an embodiment of the present invention.

FIG. 7 is a timing chart illustrating an operation according to an embodiment of the present invention.

FIG. 8 is a block diagram illustrating a total configuration of a digital still camera system using a display apparatus according to an embodiment of the present invention.

### DESCRIPTION OF THE EMBODIMENTS

In embodiments of the present invention, each of driving circuits is connected to a data line via a capacitor disposed in series between the driving circuit and the data line. A data signal is held by the capacitor, and a display element is driven in accordance with the data signal held by the capacitor. To write data signals into respective driving circuits, rows are sequentially selected by applying a control signal thereto via scanning lines, and terminals, on the side of data lines, of holding capacitors are set to be at voltages of the data signals. At the same time, the other terminal of each holding capacitor is reset such that the voltage previously held on the terminal is deleted. To drive display elements, control signals are applied to the scanning lines such that driving circuits are brought into a state in which driving circuits can drive the display elements, and a reference voltage that is predetermined independently of the video signals is applied to the data lines. As a result, the terminal, connected to the driving circuit, of each holding capacitor comes to have a voltage corresponding to the data signal. According to this voltage, the driving circuit provides a voltage or a current to the display element thereby driving the display element. Writing is performed on a row-by-row basis. In contrast, displaying is performed simultaneously for all pixels. When a displaying period starts after a writing period ends, the control signals are applied to the scanning lines simultaneously for all rows.

The data lines are applied with the data signals and the reference voltage that are generated outside the display apparatus and supplied to the data lines via sampling switches. The data lines have parasitic capacitance that occurs at intersections between the data lines and the scanning lines, and the parasitic capacitance allows the data lines to hold and maintain voltages even after the sampling switches turn off. However, when the voltages of all scanning lines change at the same time, the changes in the voltages of the scanning lines can cause the potential of the data lines to change via the parasitic capacitance.

In embodiments of the present invention, to prevent the image from being influenced by the change in potential of the data lines caused by simultaneous application of the control signals to all scanning lines, setting of voltages on the data lines is performed after the control signals are applied to the scanning lines simultaneously for all rows.

The present invention is described in further detail below with reference to specific embodiments.

### First Embodiment

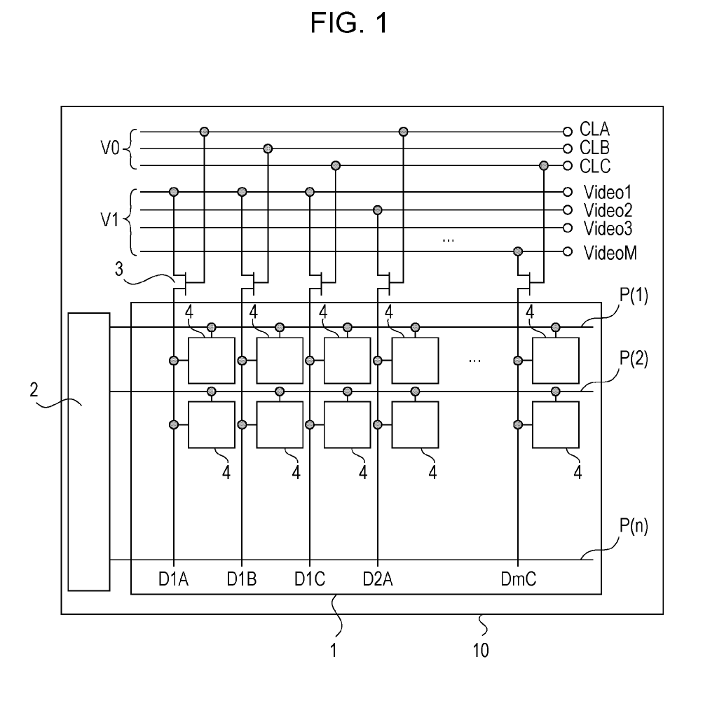

FIG. 1 is a block diagram illustrating a configuration of a display apparatus using organic electroluminescent elements according to an embodiment of the present invention.

A plurality of pixels 4 are disposed in the form of a matrix in a display area 1 of a display apparatus 10. Scanning lines P(1), P(2), . . . , P(n) are provided for respective rows of the matrix (where n is the number of rows). In FIG. 1, one scanning line is drawn in each row. However, each row may have a plurality of scanning lines as in embodiments described below. 3 m data lines D1A, D1B, D1C, D2A, D2B, D2C, . . . , DmA, DmB, DmC are disposed along columns of the matrix (where m is one third of the number of columns). The data lines are grouped such that each group includes three data lines extending in different three columns, and data signals are applied to data lines such that an R (red) data signal is applied to a data line DlA (1≦l≦m), a G (green) data signal is applied to a data line DlB (1≦l≦m), and a B (blue) data signal is applied to a data line DlC (1≦l≦m).

A scanning line driving circuit 2 is disposed on a left side of the display area 1 and control signals are supplied from the scanning line driving circuit 2 to the scanning lines P(k) (1≦k≦n).

On an upper side of the display area 1, there are sampling switches 3 provided for respective data lines, m video signal lines V1, and three switch control lines V0. Each of the sampling switches 3 is realized by a thin film transistor and is connected such that the source thereof is connected to one of the video signal lines V1, the drain is connected to one of the data lines, and the gate is connected to one of the switch control lines V0. Three sampling switches 3 connected to respective RGB data lines are turned on sequentially such that a video signal transmitted via one video signal line is sampled and output to one of the three data lines.

The video signal lines V1 transmit video signals Video1, Video2, . . . , Videom (hereinafter generically referred to as video signals Video) that are generated by a video signal generation circuit (not shown). The switch control lines V0 transmit switch control signals CLA, CLB, and CLC (hereinafter generically referred to as switch control signals CL) to control turning-on/off of the switches 3.

In the example shown in FIG. 1, the display apparatus has m video signal lines and three switch control lines, but the number of video signal lines and the number of switch control lines are not limited to those. For example, the display apparatus may include m/2 video signal lines and six switch control lines. In this case, sampling switches 3 are connected to adapt to the number of video signal lines and switch control lines.

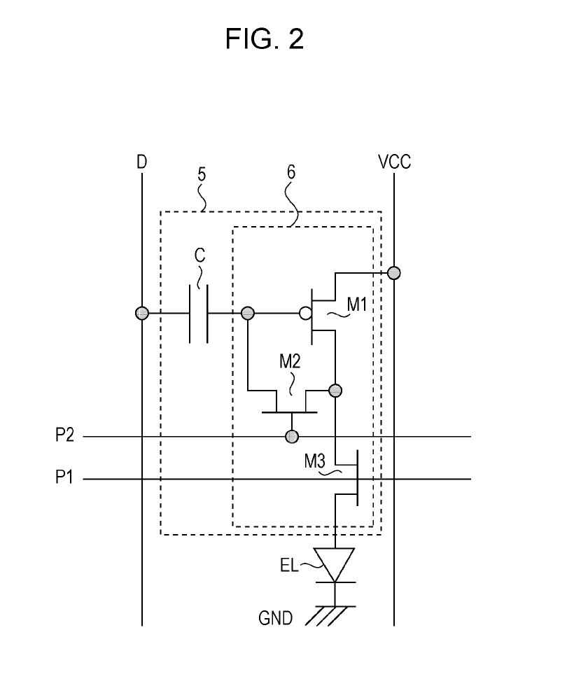

FIG. 2 is a circuit diagram illustrating a configuration of a pixel 4. The pixel 4 includes an organic electroluminescent element EL that emits light to form an image and a driving circuit 5 that drives the organic electroluminescent element EL. The driving circuit 5 includes a capacitor C and a circuit unit 6 wherein one of two terminals of the capacitor C is connected in series to one data line, and the other terminal of the capacitor C opposite to the terminal connected to the data line is connected to the circuit unit 6. The circuit unit 6 is for driving the organic electroluminescent element EL in accordance with a voltage across the capacitor C.

The circuit unit 6 includes a driving transistor M1 whose gate is connected to the terminal of the capacitor C opposite to the terminal connected to the data line. The circuit unit 6 also includes switching transistors M2 and M3 (referred to as a first switch and a second switch). A source of the driving transistor M1 is connected to a power supply line VCC, and a drain thereof is connected to one of terminals of the transistor M3 serving as the first switch. The other terminal of the transistor M3 is connected to an anode of the electroluminescent element EL. A cathode of the electroluminescent element EL is connected to a ground potential CGND provided in common for all pixels. The transistor M2 serving as the first switch is for initializing the driving circuit as described later. The transistor M2 is controlled by a scanning line P2 on a row-by-row basis. The transistor M3 serving as the second switch is controlled by a scanning line P1 such that transistors M3 are turned on sequentially on a row-by-row basis and also such that all transistors M3 are simultaneously turned on. The driving transistor M1 operates in a saturation region in which a drain current is determined by a gate-source voltage. The transistors M2 and M3 operate in a linear region such that the state of each of the transistors M2 and M3 switches between an on-state and an off-state depending on whether the gate of each of the transistors M2 and M3 is at a H (high) level or a L (low) level.

The driving circuit 5 is connected to two scanning lines P1 and P2, the data line D, and the power supply line VCC. Although only one scanning line P is drown for each row in FIG. 1, each row actually has two scanning lines P1 and P2 as shown in FIG. 2. The operation of the driving circuit 5 is controlled independently on a row-by-row basis by signals transmitted via the scanning lines P1 and P2.

The scanning lines P1 and P2 are both connected to the scanning line driving circuit 2 such that control signals generated by the scanning line driving circuit 2 are supplied via the scanning lines P1 and P2. The scanning line driving circuit 2 outputs scanning control signals to the scanning lines P1 and P2 to sequentially select pixels 4 on a row-by-row basis and write data in the selected pixels 4 and outputs a control signal to the scanning line P1 to turn on/off a path via which a current is supplied to the organic electroluminescent element EL.

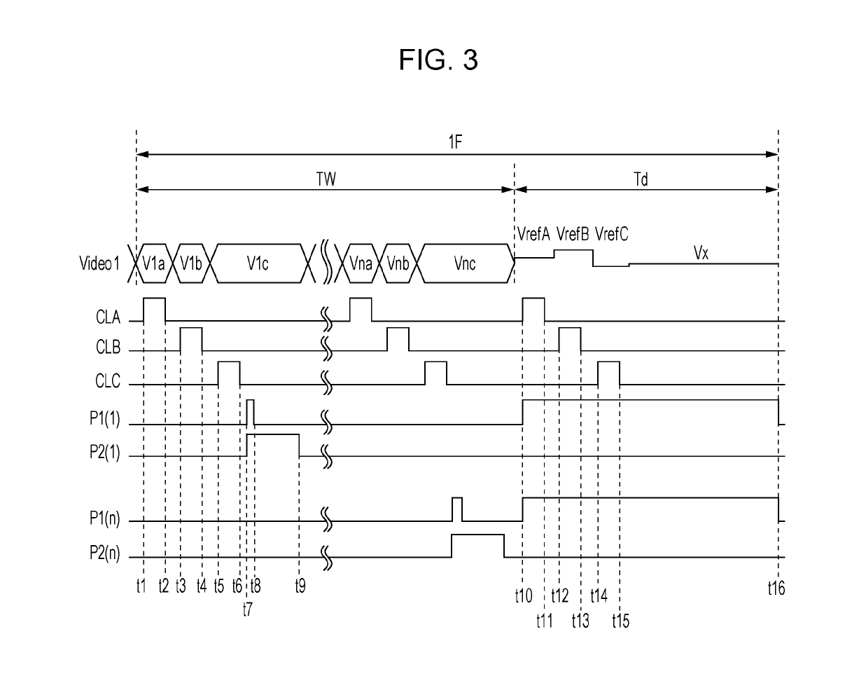

FIG. 3 is a timing chart illustrating a circuit operation of the pixel shown in FIG. 2. More specifically, the timing chart illustrates, from up to down in FIG. 2, a video signal Video1 transmitted via one of the m video signal lines V1, signals CLA, CLB, and CLC of the three switch control signals V0, control signals transmitted via scanning lines P1(1) and P2(1) in a first row, and control signals transmitted via scanning lines P1(n) and P2(n) in a n-th row. Note that video signals Video2 to Videom are also supplied via other video signal lines V1.

In FIG. 3, 1F denotes one field period that is one display cycle. One field period has two sub fields. A first sub field is a writing period Tw during which data is captured from the data line D into the driving circuit 5. A second sub field is a display period Td during which a current corresponding to the data is supplied to the organic electroluminescent element EL to emit light.

In the writing period Tw, data is sequentially captured into the driving circuit on a row-by-row basis from the first row to the n-th row.

The switch control signal CLA is at the H level from time t1 to time t2 to turn on the switch 3 connected to the data signal line DlA (1≦l≦m). The video signal Video1 is sampled when the video signal Video1 is V1a and the sampled video signal is transmitted to the data line D1A and held by capacitance Cd possessed by the data line D1A. Video signals (Video2, Video3, . . . , Videom) on other video signal lines V1 are also sampled and held by data lines DlA (2≦l≦m) in a similar manner.

After the switch control signal CLA returns to the L level, the switch control signal CLB is switched to the H level in a period from time t3 to time t4, whereby the video signal Video1 of V1b is sampled and held on the data line D1B. Similarly, in a period from time t5 to t6, the switch control signal CLC is switched to the H level whereby the video signal Video1 of V1c is sampled and held on the data line D1C. In this way, video signals are held as data signals on the data lines DlA, DlB, and DlC (1≦l≦m) for all columns.

After the video signal sampling is completed at time t6, the switch control signal CLA-CLC are set to L level and all switches 3 turn off. Thereafter, at time t7, the scanning lines P1(1) and P2(1) in the first row are switched from the L level to the H level. As a result, the transistors M2 and M3 serving as the first and second switches turn on. The gate and the drain of the driving transistor M1 are short-circuited by the transistor M2, and the drain of the driving transistor M1 is connected to the electroluminescent element EL. As a result, a current flows from the driving transistor M1 to the organic electroluminescent element EL, the gate potential is lowered, and the driving transistor M1 turns on.

At time t8, the scanning line P1(1) is switched from the H level to the L level while maintaining the scanning line P2(1) at the H level. As a result, the transistor M3 turns off, and thus the supply of the current to the electroluminescent element EL is stopped. The driving transistor M1 still remains in the state in which the gate and the drain thereof are short-circuited, and thus a drain current flows into the holding capacitor C via the transistor M2, which causes the gate potential (and the drain potential) to rise up. The rising-up of the gate potential stops when the gate-source voltage becomes equal to a threshold voltage (Vth) of the driving transistor M1 and the drain current of the driving transistor becomes zero. The resultant gate potential is held at the gate. In the above-described period from t7 to t9, the voltage previously held at the gate of the driving circuit 5 is deleted, and the voltage of the terminal, on the side of the driving transistor M1, of the holding capacitor is initialized for preparation for holding a data signal. In the driving circuit 5 according to present embodiment, the initialization is performed such that the driving transistor M1 is brought into a threshold state.

During this period, the data line D1A remains at the voltage V1a corresponding to the sampled data signal, and thus a voltage ΔV=VCC−Vth−V1a is held across the holding capacitor C. Similarly, in each other data lines, a voltage equal to the difference between the sampled voltage and the threshold voltage is held. In this state, at time t9, P2(1) returns to the L level, and writing of data of the first row into the driving circuit 5 is completed.

Subsequently, a video signal of a second row is transmitted over the video signal line V1, and, in a similar manner to the first row, the video signal is sampled and applied to the data lines DlA, DlB, and DlC according to switch control signals provided via the switch control lines CLA, CLB, and CLC and the data signals of the second row are written into the driving circuit 5 in accordance with the control signals provided via the scanning lines P1(2) and P2(2). Subsequently, writing is sequentially performed for the following rows until writing of the n-th row is completed, and the writing period Tw ends.

In the writing period Tw, the control signals P1(k) and P2(k) (1≦k≦n) on the scanning lines P1 and P2 are at the H level only when corresponding rows are selected while they are maintained at the L level when other rows are selected. Because the transistor M2 is in the off-state, the gate of the driving transistor M1 and the terminal of the holding capacitor C connected to the gate of the driving transistor M1 are in a high impedance state, and has no current flowing in or out of this terminal. Therefore, even if a change occurs in the potential on the data line D, the holding capacitor C can hold the voltage ΔV. The transistor M3 is also in the off-state, and thus even if the gate potential of the driving transistor M1 changes in response to a change in the data line potential, no current flows through the light emitting element EL and the light emitting element EL is maintained in the no-emission state.

Next, the operation in the display period Td is described below.

When the display period starts, reference voltages VrefA, VrefB, and VrefC independent of video signals are sequentially transmitted over the m video signal lines V1. The reference voltages VrefA, VrefB, and VrefC are set to have different values to achieve correct white balance, but m video signal lines V1 have the same voltage.

At time t10, the first scanning lines P1(1), P1(2), . . . , P1(n) are simultaneously switched from the L level to the H level for all rows. However, the second scanning lines P2(k) (1≦k≦n) are maintained at the L level. All driving circuits 5 are selected by the first scanning lines P1 and transistors M3 of all pixels simultaneously turn on from the off-state.

In this state, in a period from time t10 to t11, the switch control signal CLA is switched to the H level, and the reference voltage VrefA is sampled and held on the data lines DlA(1≦l≦m). Similarly, in a period from time t12 to t13, the switch control signal CLB is switched to the H level, and the reference voltage VrefB is sampled and held on the data lines DlB(1≦l≦m). In a period from time t14 to t15, the switch control signal CLC is switched to the H level and maintained at the H level, and the reference voltage VrefC is held on the data lines DlC (1≦l≦m).

When the switch control signal CLA is switched to the H level and the reference voltage VrefA is applied to the data lines DlA (1≦l≦m), the potential of the data-line-side terminal of the holding capacitor C in each driving circuit 5 in the column becomes equal to the reference voltage VrefA. Because the voltage signal V1a on the data line D has been written in the holding capacitor C during the writing period Tw and the voltage ΔV=VCC−Vth−V1a is held across the holding capacitor C, the potential of the other terminal of the holding capacitor C becomes equal to VrefA+ΔV. Because this terminal is connected to the gate of the driving transistor M1, the gate-source voltage of the driving transistor M1 becomes equal to Vgs=VCC−(VrefA+ΔV)=Vth+V1a−VrefA. Because the written data signal V1a plus the voltage equal to the threshold voltage is applied between the gate and source, a drain current generated is determined by the data signal V1a without being influenced by a variation of the threshold voltage. The circuit operation is similar for data lines DlB and DlC (1≦l≦m).

The voltage signal V1a corresponding to the data signal is determined on the assumption that the voltage signal V1a is directly applied as the gate-source voltage to the driving transistor, and thus the reference voltage Vref is normally set to 0 V. However, to adjust the luminance of the displayed image as a whole, the reference voltage Vref may be set to a value other than 0 V. Furthermore, to adjust the white balance, VrefA, VrefB, and VrefC may be set to different values. Note that if the predetermined reference voltage has an unintended change, this can cause a change in the average luminance or can deviate the white balance from the correct state.

Because the scanning line P1 is switched to the H level as the same time as the switch control signal CLA, the transistor M3 of the driving circuit 5 turns on. When the switch control signals CLA, CLB, and CLC are switched to the H level and the data lines are set to the reference potential Vref and thus the driving circuit 5 comes ready to supply a current from the driving transistor, the current immediately starts to flow through the organic electroluminescent element EL. As a result, light is emitted. The emission of light continues until all scanning lines P1 simultaneously return to the L level at time t16, i.e., at the end of the display period Td. Note that during the period in which light is emitted, the potentials of the scanning lines P1 and P2 are maintained at the H or L level.

As described above, after the scanning lines P1(1), P1(2), . . . , P1(n) of all rows are selected at the same time and switched from the L level at which no light is emitted to the H level at which light is emitted, the sampling switches 3 are sequentially turned on to set the data lines at the reference voltage level. When the sampling switches 3 turn off thereafter, the data lines D are brought into the high impedance state. However, the scanning lines P2 are maintained at the H level without being changed, and thus the reference potential on the data lines remains at the same value without being influenced by the scanning lines. Therefore, it is possible to display a correct image with no change in luminance and no deviation of white balance.

The sampling switches 3 sequentially turn on for three data lines. Therefore, at a point of time at which sampling and setting of the reference voltage is started for a first one of the data lines, raising-up of the control signal of the scanning lines needs to have already been completed. In the present embodiment, in view of the above, simultaneous raising-up of the control signals of the scanning lines P0 and P1 is performed at time t10 so that the raising-up of the control signals are performed as the same time as the first one of the switch control lines, i.e., the switch control line CLA, is raised up to the H level. Therefore, after the control signals of the scanning lines have risen, the reference voltage is set by the sampling switch. That is, the requirement described above is satisfied.

In the present embodiment, as described above, at the beginning of the writing period Tw, the transistor M2 serving as the first switch and the transistor M3 serving as the second switch are turned on whereby the potential that has been held until this moment on the gate of the driving transistor M1 is deleted. Thereafter, the transistor M3 is turned off and the transistor M2 is turned on thereby resetting the driving transistor M1 into the threshold state. Thus, the transistor M2 serving as the first switch functions as a reset switch for initializing the driving circuit 5.

At the beginning of the display period, the scanning lines P1 are simultaneously switched from the L level to the H level for all rows, and the transistor M3 serving as the second switch in each driving circuit 5 is turned on to connect the organic electroluminescent element EL to the driving transistor M1. As a result, the driving circuit 5 comes ready to drive the organic electroluminescent element EL. In this state, if the reference voltage is applied via the data lines, the data signal is transferred to the circuit unit 6 via the holding capacitor C, and a current corresponding to the data signal is supplied to the organic electroluminescent element EL. The control signals via the scanning lines P2 are supplied to select driving circuits on a row-by-row basis. In contrast, the control signals via the scanning lines P1 are supplied to select driving circuits on a row-by-row basis or simultaneously select driving circuits of all rows depending on periods. Hereinafter, the scanning lines P1 and the scanning lines P2 are distinguished such that the scanning lines P1, which supply control signals to select driving circuits on a row-by-row basis and control signals to simultaneously select driving circuits of all rows depending on periods, are referred to as main scanning lines, while the scanning lines P2, which supply control signals to select driving circuits on a row-by-row basis, are referred to as sub scanning lines.

In the present embodiment, the ratio of the number of main scanning lines to the total number of scanning lines is set to be ½. The greater the ratio, the driving circuits have the greater number of scanning lines that are all simultaneously switched in signal levels. To reduce the influence of the control signals provided via the main scanning lines on the potentials of the data lines, the ratio may be set to be smaller.

In FIG. 3, the main scanning lines P1 and the switch control signal CLA rise up at the same time (t10). Alternatively, in the display period Td, timings may be set such that the main scanning lines P1 rise up at a time earlier than a time at which the switch control signal CLA rises up.

The m video signal lines V1 may be at any voltage Vx until a next writing period starts after the reference voltages VrefA, VrefB, and VrefC have been supplied. In the present embodiment, to reduce power consumption, a power supply that provides the reference voltage is turned off such that no voltages are output during this period.

In the display period Td, switch control signals CLA, CLB, and CLC may be applied a plurality of times such that different reference voltages Vref are set at data lines each time switch control signals CLA, CLB, and CLC are applied whereby images with different luminance are displayed in one display period to reduce blurring of a moving image.

The main scanning lines P1 may be divided into groups, for example, such that a group includes main scanning lines in even-numbered rows and another group includes a main scanning lines in odd-numbered rows, and light may be emitted by applying control signals to scanning lines P1 on a group-by-group basis. In this case, after the control signal is simultaneously applied to all scanning lines P1 of a selected group, a reference voltage adaptively selected depending on emission of light in this group is set at the data lines.

### Second Embodiment

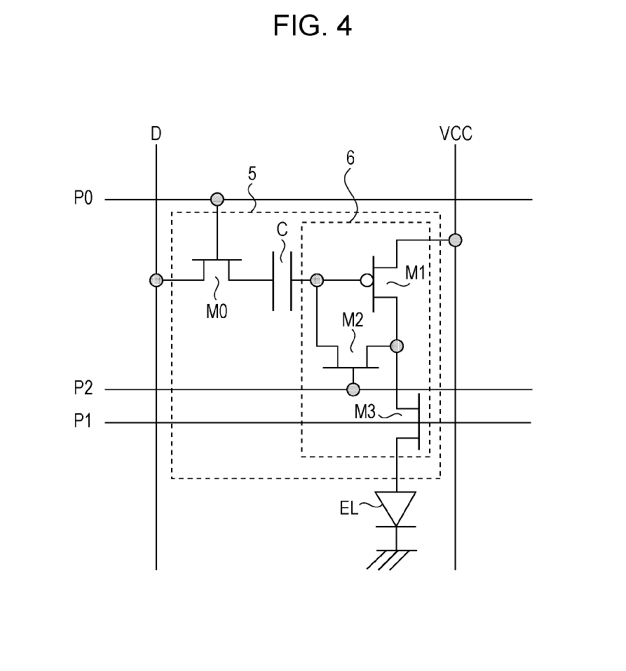

FIG. 4 is a circuit diagram illustrating a pixel 4 of an organic electroluminescence display apparatus according to a second embodiment of the present invention. Note that the display apparatus as a whole is configured in a similar manner to that shown in FIG. 1. In FIG. 4, the driving circuit 5 additionally includes a transistor M0 serving as a third switch disposed between the data line and the holding capacitor, and the gate of the transistor M0 is connected to a third scanning line P0. The holding capacitor C is connected to the data line via the transistor M0. The other parts are similar to those shown in FIG. 2, and thus a further description thereof is omitted.

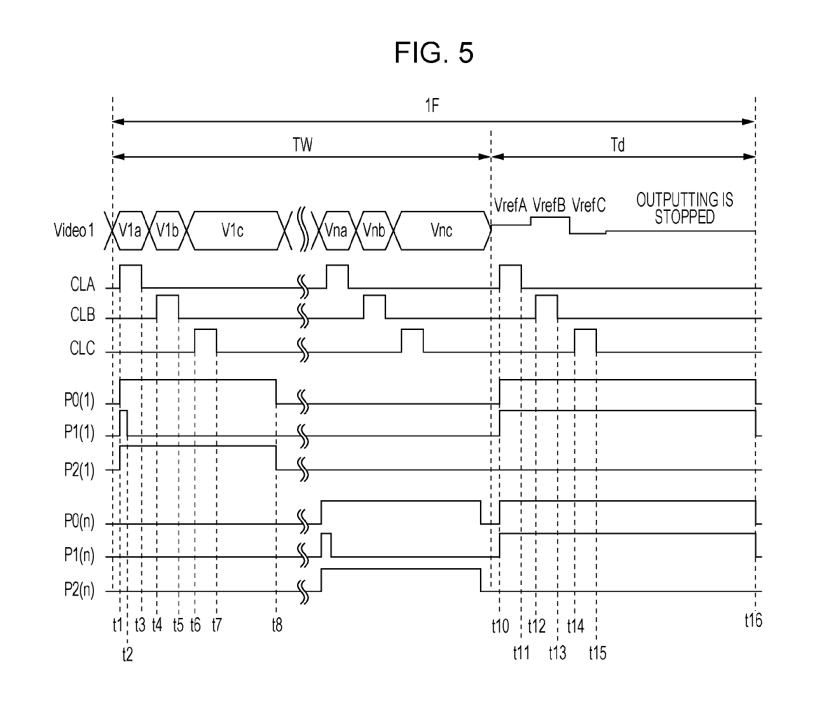

FIG. 5 is a timing chart illustrating an operation of the driving circuit 5. The timing chart shown in FIG. 5 is similar to that shown in FIG. 3 except that the timing chart shown in FIG. 5 additionally includes a control signal P0 of the third scanning line. In FIG. 5, similar signals and similar periods to those in FIG. 3 are denoted by similar reference symbols. The transistor M0 serving as the third switch is controlled by the scanning line P0 such that it is turned on sequentially from one row to another in a writing period, while, in a display period, the transistor M0 is turned on simultaneously for all driving circuits.

In a period from t1 to t8 in the writing period Tw, P0(1) is switched to the H level to select a first row. The transistor M0 of each driving circuit in the first row turns on and thus the data line D and the holding capacitor C in the driving circuit are connected. In a period from t1 to t2 in the first-row selection period, the scanning lines P1(1) and P2(1) are switched to the H level to turn on the transistors M2 and M3, and thus the driving transistor M1 comes into a diode-connected state and a current flows through the organic electroluminescent element EL, which lowers the gate potential. During a next period from t2 to t8, the transistor M3 is turned off. As a result, the drain current of the driving transistor M1 flows to the data line D through the holding capacitor C and the transistor M0. When the sampling switch is in the off-state, the data line is in the high impedance state. In this state, sufficiently large parasitic capacitance allows absorption of the current without changing the potential. This current causes the gate potential of the driving transistor M1 to rise up until the gate potential is reset to the threshold level.

Meanwhile, CLA is switched to the H level and maintained at the H level during a period from t1 to t3, CLB is switched to the H level and maintained in the H level during a period from t4 to t5, and CLC is switched to the H level and maintained in the H level during a period from t6 to t7, whereby corresponding switches 3 are closed to set corresponding data lines D at the data signals V1a, V1b, and V1c respectively. At time t8, the scanning line P0 is switched to the L level, and the first-row selection period ends. The transistor M2 turns off and a data voltage is held across each holding capacitor. More specifically, in the case of pixels in the first column, ΔV=VCC−Vth−V1a is held across the holding capacitor. In other columns, data voltages dependent on the columns are held.

Subsequently, the second row is selected, and data voltages are written in a similar manner. Thereafter, writing is performed on a row-by-row basis until writing is completed for the n-th row. When the writing is compete for all rows, the writing period ends.

In the display period Td, P0 and P1 are switched from the L level to the H level simultaneously for all rows and thus the transistors M0 and M3 are turned on. The transistor M2 is maintained in the off-state. As a result, each holding capacitor C is connected to a corresponding data line D for all pixels, and the circuit unit 6 comes ready to drive the organic electroluminescent element EL. After this state is achieved, if the data lines are set at the reference voltage VrefA, VrefB, or VrefC, inverted data signals are transferred to the terminals of the respective holding capacitors C opposite to the terminals connected to the data lines. As a result, for example in the driving circuit 5 in the first row and in the first column, the gate-source voltage Vgs becomes equal to Vgs=VCC−(VrefA+ΔV)=Vth+V1a−VrefA. This voltage causes the organic electroluminescent element EL to emit light.

In the present embodiment, as in the first embodiment, the gate of each driving transistor M1 is reset to the threshold voltage by the control signals supplied via the main scanning line P1 and the sub scanning line P2, and, during a row selection period, the driving circuit is connected to a corresponding data line by the control signal supplied via the main scanning line P0. In a non-selection period, the driving circuit is disconnected from the data line. During the non-selection period, the gate potential of the driving transistor M1 is held by the gate parasitic capacitance and maintained at the threshold voltage level. During the display period, the scanning lines P1 and P0 are simultaneously switched from the L level to the H level for all rows to turn on the transistors M3 thereby connecting the driving transistors M1 to corresponding organic electroluminescent elements EL. As a result, in each driving circuit, the circuit unit 6 comes ready to drive the organic electroluminescent element. The transistor M0 is then turned on to connect the holding capacitor to a corresponding to data line. As a result, the data voltage held is transferred to the circuit unit 6 via the holding capacitor C, and the circuit unit 6 drives the organic electroluminescent element EL.

In the driving circuit 5 according to the present embodiment of the invention, the scanning lines P2 function as sub scanning lines that supply control signals to select driving circuits only on a row-by-row basis. The scanning lines P0 and P1 function as main scanning lines that supply both control signals to select driving circuits on a row-by-row basis and control signals to select driving circuits simultaneously for all rows. In the present embodiment, the ratio of the number of main scanning lines to the total number of scanning lines is set to be ⅔.

### Third Embodiment

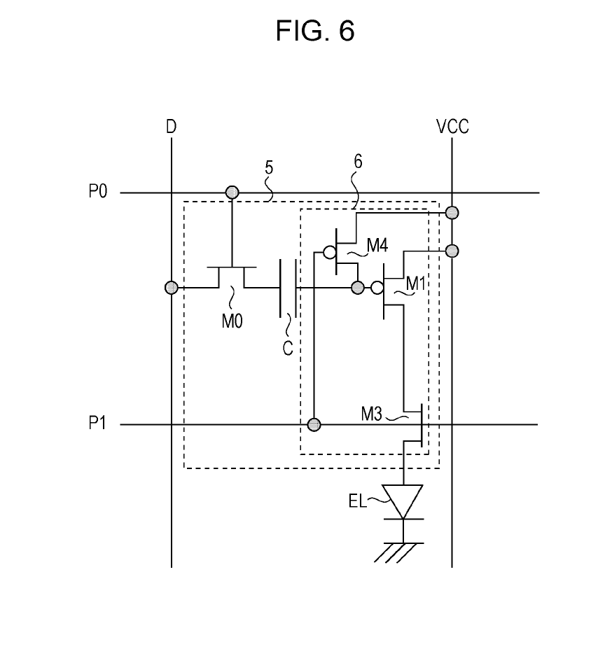

FIG. 6 is a circuit diagram illustrating a pixel 4 of an organic electroluminescence display apparatus according to a third embodiment of the present invention. Note that the display apparatus as a whole is configured in a similar manner to that shown in FIG. 1. The driving circuit 5 shown in FIG. 6 is obtained based on the driving circuit 5 shown in FIG. 4 by deleting the transistor M2 and the scanning line P2 and providing a transistor M4 functioning as a fourth switch between the power supply line VCC and the terminal connected to both the holding capacitor C and the driving transistor. The transistor M4 is of a P-channel type and the gate thereof is connected to the same scanning line P1 as that to which the gate of the transistor M3 is connected. The other parts are similar to those shown in FIG. 4.

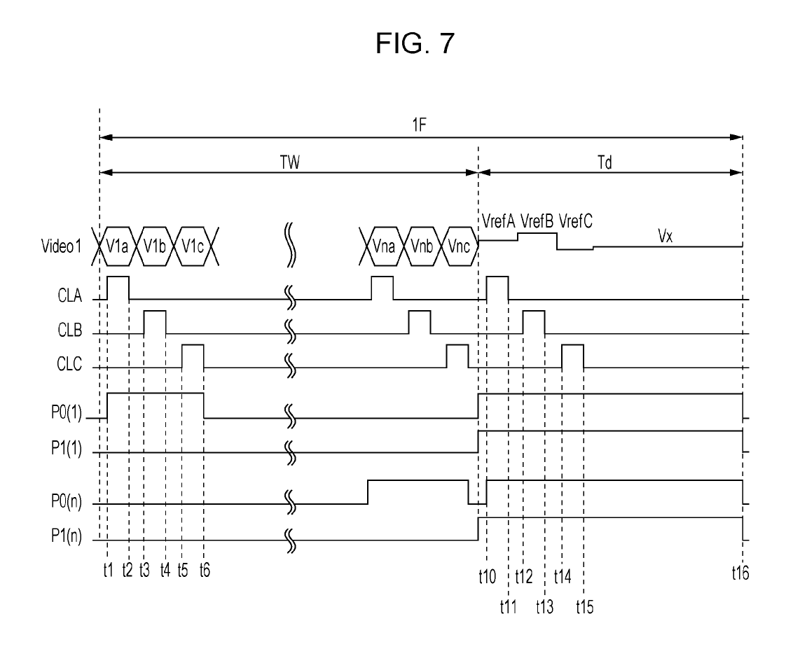

FIG. 7 is a timing chart illustrating an operation of the display apparatus according to the present embodiment of the invention. In the present embodiment, in the writing period, the transistor M4 functioning as the fourth switch is turned on for all driving circuits to set the potential of the terminal of the holding capacitor C connected to the driving transistor at Vcc. Thus, the transistor M4 functions as a reset transistor that initializes the driving circuit. In the display period, transistors M4 of all driving circuits are simultaneously turned off to allow display elements to be driven by corresponding driving transistors.

In the writing period Tw, the control signals CLA, CLB, and CLC of the switch control lines are sequentially switched to the H level in a first-row selection period from t1 to t6 to sample data signals V1a, V1b, and V1c and apply the sampled data signals to corresponding data lines. During this period, the scanning line P0(1) is switched to the H level. As a result, the transistor M0 of the driving circuit 5 in the first row turns on and the terminal of the holding capacitor C on the side of the data line is set at the potential corresponding to the data signal. In the writing period, the scanning line P1 is maintained at the L level over the entire period, while the transistor M4 is in the on-state and the transistor M3 is in the off-state, and thus the potential of the opposite terminal of the holding capacitor C is held at VCC. Therefore, after the end of the first-row selection period (from t1 to t6), a voltage corresponding to the data signal is held across the holding capacitor C. More specifically, in the case of the driving circuit 5 in the first column, ΔV=VCC−V1a is held. Subsequently, writing is sequentially performed for following rows until writing of the n-th row is completed.

When the display period Td starts, all scanning lines P0(k) and P1(k) (1≦k≦n) are simultaneously switched to the H level from the L level, and the transistor M4 turns off and the transistor M3 turns on. The terminal of the holding capacitor C connected to the driving transistor M1 is disconnected from VCC and is brought into a floating state. However, small parasitic capacitance on the gate of the driving transistor M1 allows the terminal to be substantially held at the potential corresponding to VCC. Thereafter, the control signals CLA, CLB, and CLC of the switch control lines are sequentially switched to the H level to sample the reference voltages VrefA, VrefB, and VrefC and apply the sampled reference voltages to corresponding data lines. For example, in the driving circuit 5 in the first row and in the first column, the gate potential becomes equal to ΔV+VrefA and the gate-source voltage of the driving transistor M1 becomes equal to Vgs=VCC−(ΔV+VrefA)=V1a−VrefA. In other pixels, a voltage corresponding to a data signal is held across a holding capacitor C in each pixel in a similar manner. As a result, a driving current corresponding to the data signal flows from the drain of the driving transistor M1 to the organic electroluminescent element EL. In the present embodiment, it is assumed that the variation of characteristics among driving transistors is negligibly small, and the reference voltage is set to be equal to the data signal plus the threshold voltage.

In the present embodiment, the driving circuit 5 is initialized at the beginning of the writing period such that the potential of the gate of the driving transistor M1 is rest to VCC. In the display period, the driving transistor is connected to the organic electroluminescent element EL and the data line is connected to the holding capacitor. As a result, the circuit unit 6 comes ready to drive the organic electroluminescent element EL.

The scanning lines P0 supply both control signals to select driving circuits on a row-by-row basis and control signals to select driving circuits simultaneously for all rows. On the other hand, the control signals via the scanning lines P1 all simultaneously change, and thus the scanning lines P1 may be disposed in the column direction.

In the pixel configuration shown in FIG. 6, the connection between the power supply line VCC and the terminal of the holding capacitor C on the side of the driving transistor is controlled simultaneously for all rows by the control signals supplied via the scanning lines P1. Alternatively, the operation of connecting the terminal of the holding capacitor C on the side of the driving transistor to VCC and resetting the state in which the driving circuit has been until this moment may be performed on a row-by-row basis in synchronization with the control signals of the scanning lines P0. In this case, an additional scanning line is provided to sequentially turn on transistors M4 in synchronization with turning-on of transistors M0 in the writing period Tw. During the display period Td, each transistor M4 is maintained in the off-state. The scanning lines P1 are provided to extend in the column direction, and the third scanning lines are added to the scanning lines P0, and thus the ratio of the number of main scanning lines to the total number of scanning lines is ½.

In the present embodiment, as shown in FIG. 7, timings are set such that the scanning lines P0 and P1 rise up at a time slightly earlier than a time t10 at which the switch control signal CLA rises up in the display period Td. When a delay occurs in some control signals of scanning lines, if the delay is within the interval between the above-described two rising timings, it is ensured that the reference potential is set after the switching of the control signals of the scanning lines is completed, and thus it is ensured that the potentials of the data lines are prevented from being influenced by the switching of the control signals of the scanning lines.

The circuit unit 6 drives the display element according to the voltage on the terminal of the holding capacitor C opposite to the terminal on the side of the data line. In the first to third embodiments described above, organic electroluminescent elements are used as display elements. Alternatively, liquid crystal elements may be used. Liquid crystal elements are driven by applying a voltage thereto. Therefore, the circuit unit 6 is modified such that the driving transistor M1 and the transistor M3 are removed from the circuit configuration shown in FIG. 6, and the terminal of the capacitor C opposite to the terminal on the side of the data lines is directly connected to a pixel electrode of the liquid crystal element. The transistors M0 and M4 are turned on from one row to another to hold the data signal across the holding capacitor. Thereafter, if the transistor M0 is turned on simultaneously for all rows, a voltage signal which is an inversion of the data signal is applied to the liquid crystal element.

### Fourth Embodiment

An information display apparatus may be realized using a display apparatus configured in the above described manner. The information display apparatus may be a portable telephone, a portable computer, a digital still camera, or a video camera, or the information display apparatus may be an apparatus having two or more functions described above.

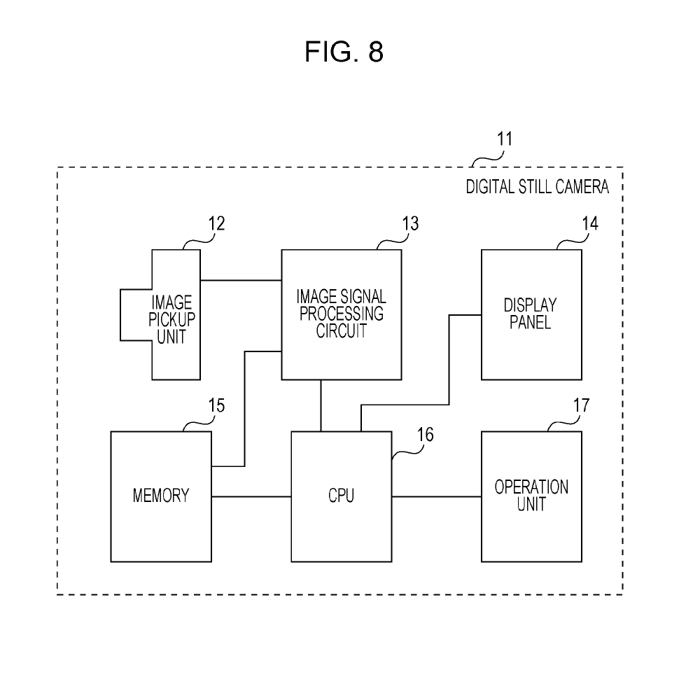

FIG. 8 is a block diagram illustrating a digital still camera system 11 using a display apparatus according to an embodiment of the present invention. An image taken by an image pickup unit 12 or an image stored in a memory 15 is processed by an image signal processing circuit 13 and displayed on a display panel 14 realized using the display apparatus according to the embodiment of the invention. A CPU 15 performs an operation of taking, storing, playing back, and/or displaying an image by controlling the image pickup unit 12, the memory 15, and the image signal processing circuit 13 according to a command or data input via an operation unit 17. The display apparatus according to an embodiment of the invention may be used as a display unit of a wide variety of other electronic devices.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-036553 filed Feb. 22, 2010, which is hereby incorporated by reference herein in its entirety.

What is claimed is:

1. A display apparatus comprising: a plurality of display elements and a plurality of driving circuits for driving respective display elements, both arranged in the form of a matrix; a plurality of data lines each configured to hold a voltage signal and supply the voltage signal to the driving circuits arranged in a column of the matrix; a plurality of scanning lines intersecting the plurality of data lines each configured to supply a control signal to the driving circuits arranged in a row of the matrix; and a plurality of video signal lines configured to transmit the voltage signal to the plurality of data lines via a plurality of sampling switches connected between the plurality of video signal lines and the plurality of data lines,
wherein the plurality of scanning lines are configured such that:
after the sampling switches turn on and the voltage signal which is to be held in the driving circuit is transmitted to the plurality of data lines and subsequently the sampling switches turn off, a scanning line selected from the plurality of scanning lines supplies the control signal to the driving circuits thereby causing the driving circuits along the selected scanning line to hold the voltage signal,
the plurality of scanning lines supply the control signal to the driving circuits simultaneously, and thereafter the sampling switches turn on and the voltage signal which causes the driving circuit to drive the display element is transmitted to the plurality of data lines thereby causing the driving circuits along the plurality of scanning lines to drive the display elements simultaneously.

2. The display apparatus according to claim 1, wherein
each of the driving circuits includes a transistor and a capacitor, the transistor being connected such that a gate of the transistor is connected to a power supply and a drain of the transistor is connected to a gate of the transistor via a first switch and the drain is also connected to the display element via a second switch, the capacitor being connected between the gate of the transistor and the data line,
the control signal supplied by the selected scanning line is a control signal that turns on the first switch, and
the control signal supplied by the plurality of scanning lines simultaneously is a control signal that turns on the second switch.

3. The display apparatus according to claim 2, wherein
each of the driving circuits includes a third switch that connects a corresponding data line to the capacitor in the driving circuit, and
the control signal supplied by the selected scanning line and the control signal supplied by the plurality of scanning lines simultaneously are both control signals that turn on the third switch.

4. The display apparatus according to claim 2, wherein each of the driving circuits includes a fourth switch that connects the gate to the power supply, and
the control signal supplied by the plurality of scanning lines simultaneously is a control signal that turns off the fourth switch.
